(19) United States
(12) Patent Application Publication
(10) Pub. No.: US 2004/0136297 A1
(43) Pub. Date: Jul. 15, 2004

(54) Method for determining disc type

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/746,179

(22) Filed: Dec. 24, 2003

(30) Foreign Application Priority Data
Dec. 26, 2002 (TW) 91137450

(51) Int. Cl. G11B 7/00

(52) U.S. Cl. 369/53.23

(57) ABSTRACT

The present invention discloses a method for determining disc type. Perform a focus servo process by emitting a light beam with a specific wavelength and a focus error signal is generated. According to the overshooting value after the focus error signal forming an S curve, the disc type is determined.

### BACKGROUND OF THE INVENTION

1. Field of the Invention

The present invention relates to a method for determining disc type, and in particular to a method for determining disc type with a focus error signal.

2. Description of the Related Art

To quickly read information stored on disc, optical storage devices must determine disc type quickly and precisely to allow the pickup head to read data on the disc.

Conventional methods for this are disclosed in Taiwan patent No. 397969 “Disc discrimination device and disc discrimination method”. Protection layer thickness on a CD is about 1.2 mm, and on a DVD is about 0.6 mm. Conventionally, disc type is determined according to the thickness difference therebetween.

As shown in FIGS. 1a and 1b, the conventional method emits a light beam toward the disc from a light source 100. An optical sensor 120 receives the light beam reflected from the disc in segments 121 and 122. Distance between surface of the protection layer and the recording layer is calculated.

As shown in FIG. 1a, a CD 110 reflects the light beam to the optical sensor 120 such that segment 122 receives more light intensity than segment 121. By comparing voltage difference from segments 121 and 122, a thickness for protection layer 110 is obtained.

As shown in FIG. 1b, a DVD 115, with protection layer thinner than that of the CD 110, reflects the light beam to the optical sensor 120 such that segment 121 receives more light intensity than segment 122. By comparing voltage difference transmitted from segments 121 and 122, a thickness for protection layer 115 is obtained. Thus, the conventional method determines disc type.

The conventional method, however, requires additional optical sensors, increasing costs, taking more time, and complicating process.

### SUMMARY OF THE INVENTION

Thus, there is a need for a simpler and more economical method for determining disc type.

The method for determining disc type comprises performing a focus servo process by emitting a light beam with a specific wavelength to the disc for generating a focus error signal. According to an overshooting value of the focus error signal after the focus error signal forming an S curve, disc type is determined.

### BRIEF DESCRIPTION OF THE DRAWINGS

The present invention can be more fully understood by reading the subsequent detailed description and examples with references made to the accompanying drawings, wherein:

FIG. 1a is a schematic diagram of a conventional method for determining disc type with a CD in an optical drive;

FIG. 1b is a schematic diagram of a conventional method for determining disc type with a DVD in an optical drive;

FIG. 2 shows the reading structure of a pickup head;

FIG. 3a shows the reflecting light path that focus point is on the recording layer;

FIG. 3b shows the reflecting light path that focus point is in the rear of the recording layer;

FIG. 4a shows a light spot projected on an optical sensor when focus point is in the rear of the recording layer;

FIG. 4b shows a light spot projected on an optical sensor when the pickup head arrives the focus position;

FIG. 4c shows a light spot projected on an optical sensor when the focus point is in front of the recording layer;

FIG. 5 shows a focus error signal as a pickup head detects a CD with a CD laser;

FIG. 6 shows a focus error signal as a pickup head detects a DVD with a DVD laser;

FIG. 7 shows a focus error signal as a pickup head detects a DVD with a CD laser;

FIG. 8 is a flow chart of the steps of the present invention.

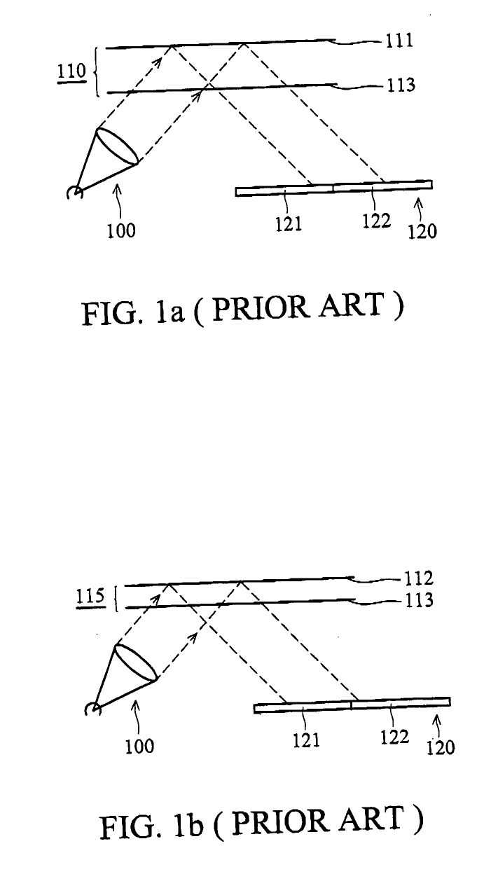

### DETAILED DESCRIPTION OF THE INVENTION

Firstly, a focus servo process is described as follows.

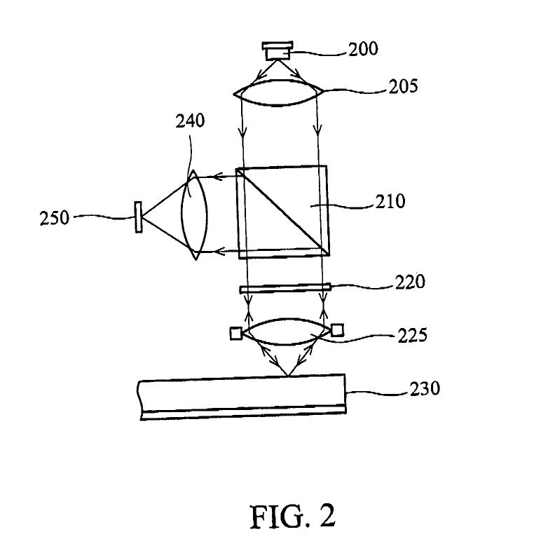

FIG. 2 shows the reading structure of a pickup head, comprising a semiconductor laser 200, a collimator lens 205, a beam splitter 210, a quarter-wave plate 220, a condenser lens 225, a lens 240, and an optical sensor 250. The semiconductor laser 200 emits a light beam through the collimator lens 205, the beam splitter 210, the quarter-wave plate 220, and the condenser lens 225, to a disc 230. The disc 230 reflects the light beam from the disc 230 through the condenser lens 225, the quarter-wave plate 220, the beam splitter 210, and a lens 240 to an optical sensor 250.

When a disc is loaded into an optical storage device, the pickup head moves near and then away the disc for detecting the precise position of the recording layer. At the precise position, the focus point is on the recording layer. The procedure of finding the precise position of pickup head is called the focus servo process. A signal for optical storage device to determine whether the pickup head is at the precise position or not is called the focus error signal. The focus error signal is described follows.

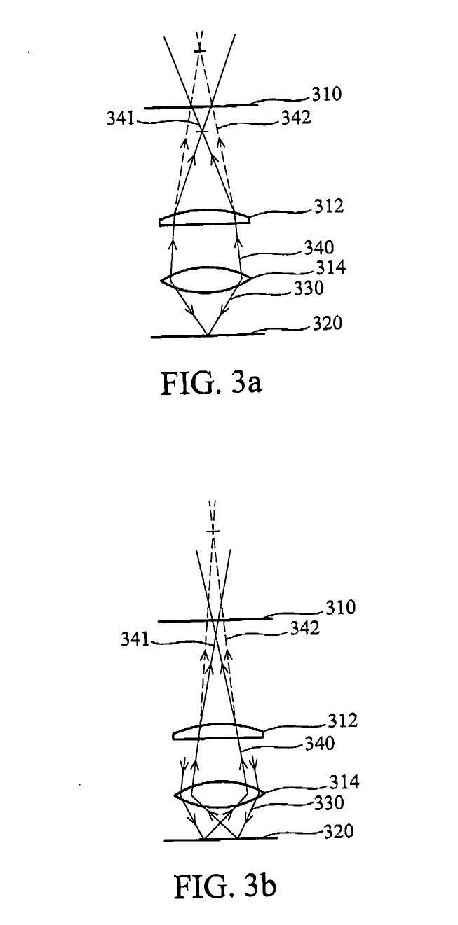

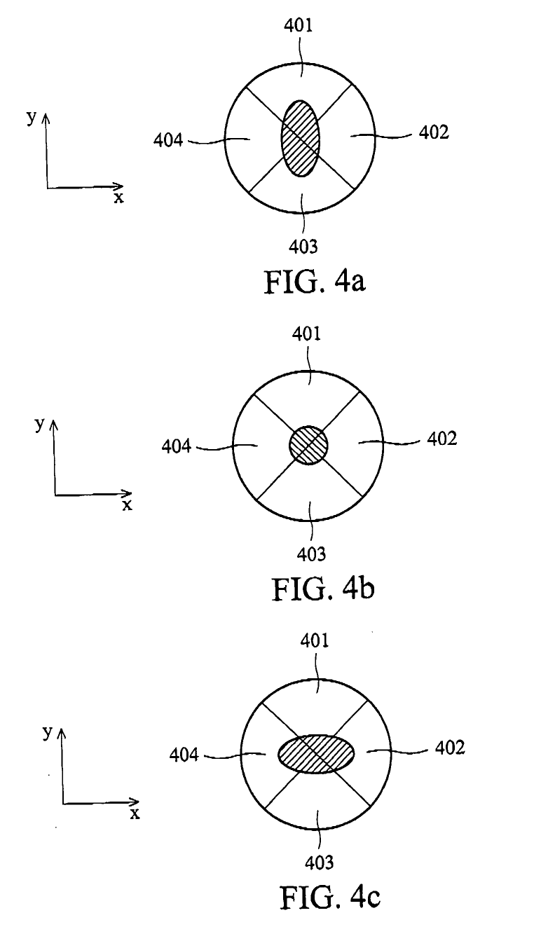

FIGS. 3a and 3b show the reflecting light path that focus point is on the recording layer and not on the recording layer. As shown in FIG. 3a, when the pickup head is at the precise position, the focus point of the light beam 330 is on recording layer 320 of the disc and the reflected beam forms a spot on an optical sensor 310 through a lens 314 and 312. The spot formed on the optical sensor has equal lengths in x-axis direction and Y-axis direction. As shown in FIG. 4b, when the pickup head is at the focus position, the spot is a circular light spot (equal length in X and Y direction) on detection segments 401, 402, 403, and 404 of the optical sensor 310. The x-axis detection segments 402, 404 receive the same light intensity as the y-axis detection segments 401 and 403. Then, a difference amplifier subtracts voltage signals of the detection segments 401 and 403 from voltage signals of the detection segments 402 and 404, and produces the focus error signal value of zero.

As shown in FIG. 3b, when the focus point of the incident beam 330 is near the recording layer 320 and is in the rear of the recording layer 320 of the disc, the spot formed on the optical sensor has not equal lengths in x-axis direction and Y-axis direction. As shown in FIG. 4a, when the pickup head is too close to the disc 320, the focus point of the incident beam 330 is near the recording layer 320 and is in the rear of the recording layer 320 of the disc. The formed spot is an oval light spot (longer length in Y direction and shorter length in X direction) on detection segments 401, 402, 403, and 404 of the optical sensor 310. The x-axis detection segments 402, 404 receive less light intensity than the y-axis detection segments 401, 403. The difference amplifier subtracts the voltage signals of the detection segments 401 and 403 from the voltage signals of the detection segments 402 and 404, producing a negative focus error signal value.

As shown in FIG. 4c, when the focus point of the incident beam 330 is near the recording layer 320 and is in front of the recording layer 320 of the disc. The formed spot is an oval light spot (longer length in X direction and shorter length in Y direction) on detection segments 401, 402, 403, and 404 of the optical sensor 310. The x-axis detection segments 404, 402 receive more light intensity than the y-axis detection segments 401, 403. Thus, the difference amplifier produces a positive focus error signal value after subtracting the voltage signal of the detection segments 401 and 403 from the voltage signal of the detection segments 402 and 404.

According to FIGS. 4c, 4b, and 4a, when the focus servo process is activated, the pickup head moves from an initial position toward the disc, the value of focus error signal will change from positive to negative When the pickup head is at the initial position (far from the disc), the reflected beam i s weak, and the focus error signal closes to zero. As the pickup head closes to the disc and the focus point is in front of t he recording layer, the focus error signal strengthens, with a positive peak value 511. As the pickup head continues to near the disc, the value of the focus error signal decreases, reaching zero when the pickup head is in the precise position. As the pickup head continues to near the disc and the focus point is in the rear of the disc, the focus err or signal decreases, first to a negative peak value, then to zero value. The waveform of focus error signal formed by moving the pickup head close to the disc is called S curve.

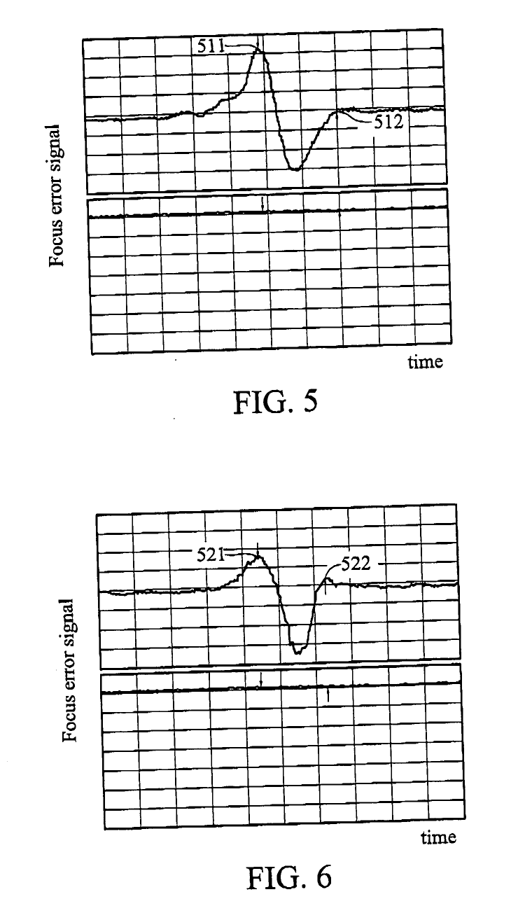

As shown in FIG. 5, when the focus servo process uses a CD laser (wavelength 780 nm) to detect a CD, the S curve of the focus error signal first reaches positive peak value 511 and then decreases to a negative peak value. After the S curve of the focus error signal formed and the signal again rising to the zero cross point, the overshooting value 512 of the focus error signal is lower.

As shown in FIG. 6, when the focus servo process uses a DVD laser (wavelength 650 nm) to detect a DVD, the overshooting value after the focus error signal forming the S curve is higher.

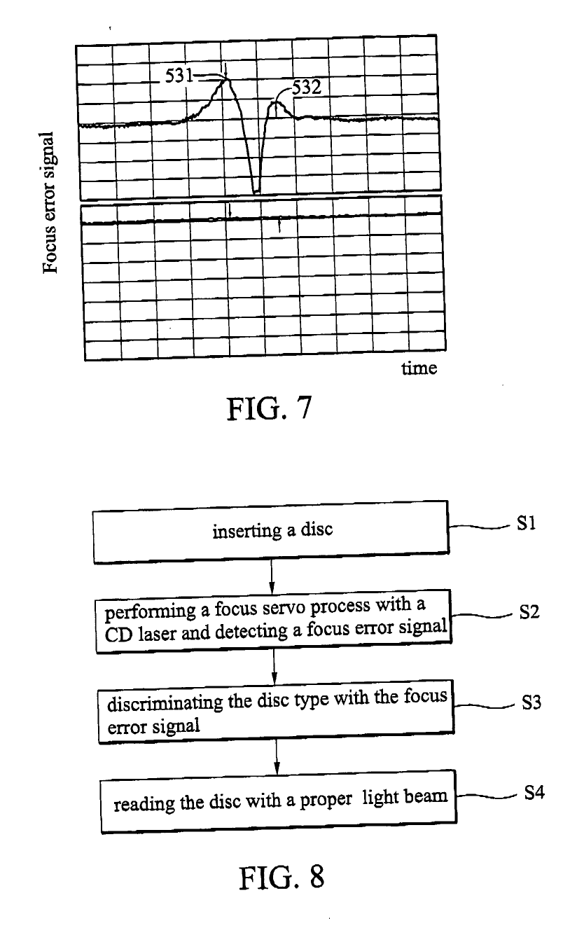

If use the CD laser to detect the DVD, the overshooting value after the focus error signal forming the S curve is the highest. As shown in FIG. 7, when the focus servo process uses a CD laser (wavelength 780 nm) to detect a DVD, the overshooting value 532 after the focus error signal forming the S curve is the highest.

Thus, at the start up procedure of an optical storage device, the pickup head performs the focus servo process with a CD laser. If the focus error signal has an obvious overshooting value after the focus error signal forming the S curve, the optical storage device determines the loaded disc is a DVD. If there is no obvious overshooting value after the focus error signal forming the S curve, the optical storage device determines the loaded disc is a CD.

FIG. 8 shows the determination process. When a disc is loaded into the optical storage device (step S1), the pickup head performs the focus servo process with a CD laser (step S2). Then, the optical storage device determines the disc type according to the overshooting value after the focus error signal forming the S curve. Finally, the optical storage device uses an appropriate laser (CD laser or DVD laser) to read the determined disc.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A method for determining disc type, comprising the steps of:
performing a focus servo process by emitting a light beam with a specific wavelength to a disc for generating a focus error signal; and
determining disc type by a overshooting value after the focus error signal forming an S curve.

2. The method of claim 1, wherein the specific wavelength has a wavelength of about 780 nm.

3. The method of claim 1, wherein the disc is a CD.

4. The method of claim 1, wherein the disc is a DVD.

5. The method of claim 1, further comprising a step of determining an appropriate light beam to reading the determined disc.
